(19) United States
(12) Patent Application Publication
(10) Pub. No.: US 2019/0093823 A1
(43) Pub. Date: Mar. 28, 2019

(54) FLUID TRANSFER TUBE

(71) Applicants: Steven Richard Scott, Curlew, WA (US); Jeffrey Nicholas Wilson, Roseville, CA (US)

(72) Inventors: Steven Richard Scott, Curlew, WA (US); Jeffrey Nicholas Wilson, Roseville, CA (US)

(21) Appl. No.: 15/714,603

(22) Filed: Sep. 25, 2017

(51) Int. Cl. F17C 5/00; F17C 13/12; B67D 7/78; B65B 1/30

(52) U.S. Cl. CPC F17C 5/007; F17C 13/123; B67D 7/78; F17C 2270/01; F17C 2205/0364; F17C 2223/036; B65B 1/30

(57) ABSTRACT

A fluid transfer tube having a probe tube having first and second ends, the first end having at least one fluid transfer entrance port, the second end having at least one fluid transfer exit port, and an anti-cavitation fin extending from said first end to said second end.

### TECHNICAL FIELD

The present invention relates generally to devices for refueling mechanical devices.

### BACKGROUND ART

There are several situations in which motorized equipment operates using a supply of volatile fuel such as gasoline or kerosine. When equipment must be operated continuously in order to function properly, there is a need to replenish the supply of fuel quickly, safely, and possibly while the motorized equipment continues to function uninterrupted.

One such example of this kind of situation is when gasoline-powered chain saws are used to cut away trees, brush and foliage during a forest fire, in order to create fire breaks. When a fire-fighter needs to refuel his saw, while acting in a dangerous environment with open flames near at hand, it is extremely crucial that transfer of flammable fuel is conducted in an extremely safe manner. Since gasoline is notoriously volatile, it is extremely important that refueling operations do not allow the release of volatile vapors that can ignite with potentially deadly consequences. Thus there is a need for an apparatus and method that can transfer volatile fluids in a manner which contains flammable vapors from the fuel as it is being transferred to the operating saw.

Time is of the essence when in such hazardous conditions, so speeding the transfer of fuel is very important. The tube through which the fluid fuel travels from the fuel tank to the mechanical device can be a crucial bottleneck which limits the speed of refueling. In particular, cavitation in the fluid as it is poured or pumped can slow the overall transfer rate. Cavitation is the formation of vapour cavities in a liquid, that usually occur when a liquid is subjected to rapid changes of pressure that cause the formation of cavities in the liquid where the pressure is relatively low. When subjected to higher pressure, the voids implode and can generate shock waves that cause turbulence. This opposes the smooth flow of fluid and reduces flow rates. By contrast, flow that is smooth or laminar, without turbulence, can be much more efficient in transferring fluid and produces higher flow rates.

Also, when fluid is entering a close container, air must be displaced as the fluid takes up that volume of air. Escaping air can oppose the smooth in-flow of fluid by creating pressure that the fluid must oppose, or by creating turbulence or cavitation, as bubbles escape and churn the fluid. This disrupts the smooth laminar flow and decreases efficiency.

What is needed is a fluid transfer tube that maintains smooth laminar flow of the fluid, and which preferably also allow for controlled venting of the displaced air, which all leads to faster fluid transfer rates.

Thus, there is a need for a fluid transfer tube that maintains laminar fluid flow and controlled venting of air during refueling operations.

### DISCLOSURE OF INVENTION

Briefly, one preferred embodiment of the present invention is a fluid transfer tube that produces faster fluid transfer rates.

An advantage of the present invention is that it provides increased fluid transfer rates.

Another advantage is that the fluid transfer tube provides laminar flow for fluids by including at least one anti-cavitation fin.

A further advantage of the present invention is that the fluid transfer tube includes an air exchange tube which improves the fluid transfer rate.

Another advantage of the present invention is that it works on a fluid exchange principle, instead of a displacement principle.

These and other advantages of the present invention will become clear to those skilled in the art in view of the description of the best presently known mode of carrying out the invention of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIG. 1 shows a fueled device, specifically a chain saw, being refueled using a volatile fluid transfer device which includes the present fluid transfer tube;

FIG. 2 shows an isometric view of the fluid transfer tube of the present invention;

FIG. 3 shows a cut-away isometric view of the fluid transfer tube of the present invention;

FIG. 4 shows another isometric view of the fluid transfer tube of the present invention; and

FIG. 5 shows another cut-away isometric view of the fluid transfer tube of the present invention.

### DETAILED DESCRIPTION OF THE PREFERRED EMBODIMENTS

The present invention is a fluid transfer tube 10. It is preferably used in a volatile liquids refueling apparatus as disclosed in U.S. patent application Ser. No. 15/449,985, filed Mar. 5, 2017, which is incorporated by reference herewithin, by one of the present inventors.

This apparatus has a probe which engages a fuel tank and a receiver which makes a vapor-tight connection to a fueled device, such as a chain saw, for use in situations in which volatile vapors could be ignited if not contained. Within this apparatus is a connecting tube, referred to as central tube 40 in this previous patent application. The present fluid transfer tube 10 can replace this previous central tube as a mechanism for providing faster fluid transfer rates by reducing turbulence and cavitation. It is emphasized that this present fluid transfer tube 10 is not limited to this one application and that it can be used in a variety of applications where improved fluid transfer rate is desireable. For the sake of this discussion, it will be assumed that the fluid transfer tube is being used with the previously described volatile liquids refueling apparatus. Moreover, the internal mechanism which acts to provide the improved fluid transfer rate, discussed later as fin and air exchange tube assembly 40, can be used in various other application which do not use the particular tube configuration described below.

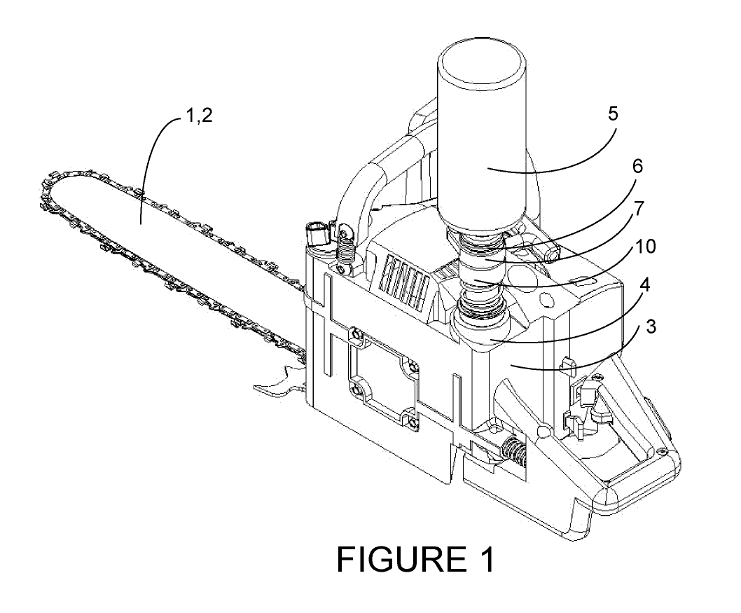

Referring now to FIG. 1, a fueled mechanical device 1 is shown, which in this case is a chain saw 2, having a device fuel tank 3 with a device fuel tank port 4. An external fuel tank 5 has a fuel tank port 6, and a volatile liquids refueling device 7 is shown attached between the external fuel tank port 6 and the device fuel tank port 4, as refueling is conducted. The present fluid transfer tube 10 is included in the volatile liquids refueling device 7 to provide increased fluid transfer rates and faster refueling times.

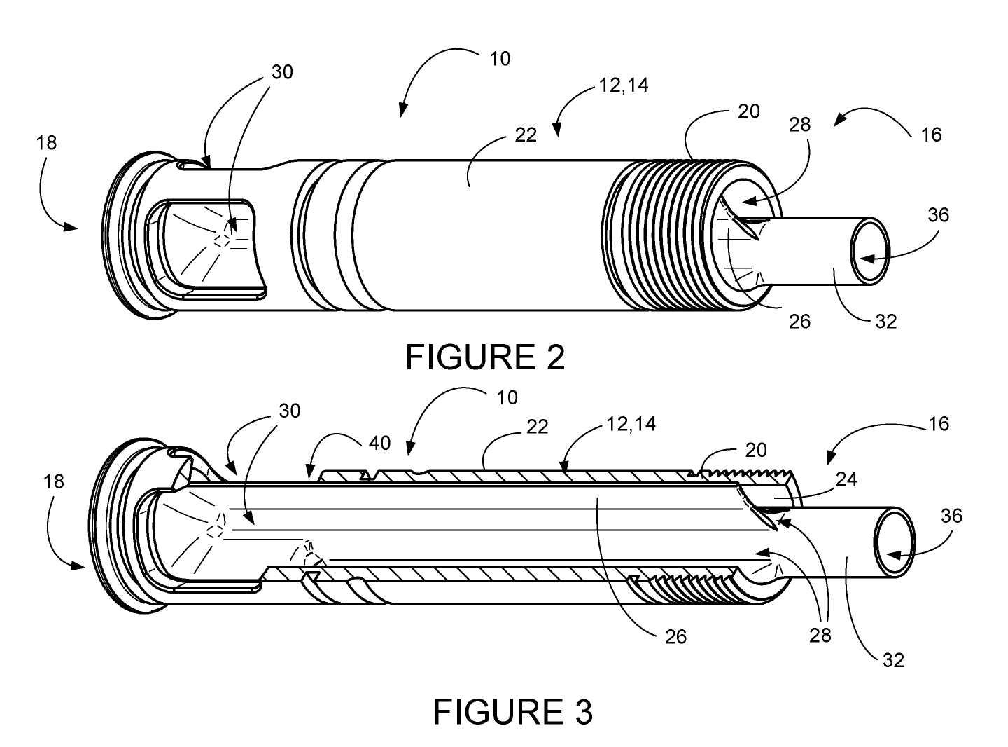

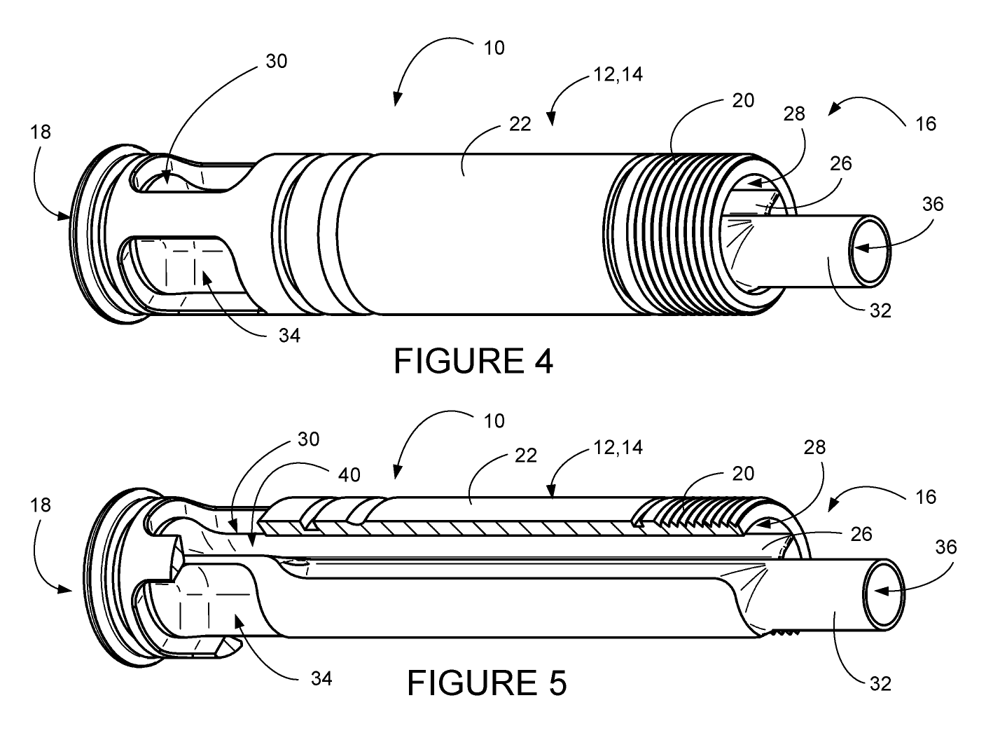

Referring to FIGS. 2-5, the fluid transfer tube 10 generally includes a probe 12, having a probe tube 14. This probe tube 14 has a proximal end 16 and a distal end 18, where the proximal end 16 has male screw threads 20 which engage with female screw threads 6 on a fuel tank 5 or with an adaptor (not shown) with internal female threads and external male threads which engage female threads on a fuel tank 5. The probe tube has an exterior surface 22, and an inner bore 24 which encloses an anti-cavitation fin 26. The probe tube 14 has at least one fluid entrance port 28 located at the proximal end 16, and at least one fluid exit port 30 located at the distal end 18 of the probe tube 14.

The anti-cavitation fin 26 extends in the interior of probe tube 14 from the proximal end 16 to the distal end 18 of the fluid transfer tube 10. Cavitation is the formation of vapour cavities in a liquid, that usually occur when a liquid is subjected to rapid changes of pressure that cause the formation of cavities in the liquid where the pressure is relatively low. When subjected to higher pressure, the voids implode and can generate shock waves that cause turbulence. This opposes the smooth flow of fluid and reduces flow rates. By contrast, flow that is smooth or laminar, without turbulence, can be much more efficient in transferring fluid and produces higher flow rates. The anti-cavitation fin 26 is very effective in maintaining laminar flow and thus improving the fluid flow rate. The thickness of the fin anti-cavitation 26 is preferably in the range of 1% to 5% of the probe tube 12

The fluid transfer tube 10 also preferably includes an anti-cavitation air exchange tube 32, by which air in the fueled device's tank is allowed to escape, thus decreasing opposing pressure and aiding in the increased rate of fuel transfer. This is considered to be an optional feature, and the fluid transfer tube 10 will provide increased rate of transfer with the anti-cavitation fin 26 alone, but this is enhanced by use of the air exchange tube 32.

The air exchange tube 32 has an air flow pattern that is opposite to the incoming fluid flow, and so has one or more entrance ports 34 near the distal end 18 of the tube 12. The air flow path then leads to the exit port 36 near the proximal end 16 of the tube. This flow pattern works on a fluid exchange principle, instead of a displacement principle, which produces faster fluid transfer rates.

It has been found that a desirable diameter for this air exchange tube 32 is 1 to 45% of the main tube 12 diameter, with a thickness of 0.010 to 0.05 inches.

It is thought that the anti-cavitation fin 26 and air exchange tube 32 may be used as an fin and tube assembly 40 in other tubes in which it is desirable to maintain laminar flow with reduced turbulence and cavitation. Thus, this fin and tube assembly 40 may be fabricated as an insert that may be placed in other types of tubes or short hoses.

While various embodiments have been described above, it should be understood that they have been presented by way of example only, and not limitation.

1. A fluid transfer tube comprising:
a probe tube having first and second ends, said first end having at least one fluid transfer entrance port, said second end having at least one fluid transfer exit port, and an anti-cavitation fin extending from said first end to said second end.

2. The fluid transfer tube of claim 1, having at least two fluid transfer entrance ports.

3. The fluid transfer tube of claim 1, having at least two fluid transfer exit ports.

4. The fluid transfer tube of claim 1 further comprising:
an air exchange tube.

5. The fluid transfer tube of claim 4 wherein said air exchange tube includes at least one entrance port and one exit port.

6. The fluid transfer tube of claim 1 wherein said anti-cavitation fin has a thickness which is in the range of 1%-5% of the diameter of the probe tube.

7. The fluid transfer tube of claim 4 wherein said air exchange tube diameter is in the range of 1%-45% of the diameter of the probe tube.

8. A fin and air tube assembly comprising:
an anti-cavitation fin; and
an air exchange tube.

9. The fin and air tube assembly of claim 8, wherein said anti-cavitation fin has a thickness which is in the range of 1%-5% of the probe tube.

10. The fin and air tube assembly of claim 8, wherein air exchange tube air exchange tube diameter is in the range of 1% to 45% of the diameter of the probe tube.
